(19) United States
(12) Patent Application Publication
(10) Pub. No.: US 2025/0371891 A1
(43) Pub. Date: Dec. 4, 2025

(54) INFORMATION PROCESSING DEVICE, CELL PROCESSING APPARATUS, SEEDING CELL QUANTITY DETERMINATION METHOD, AND CELL PROCESSING METHOD

(71) Applicants: Canon Medical Systems Corporation, Otawara-shi (JP); CANON KABUSHIKI KAISHA, Tokyo (JP)

(72) Inventors: Kenta KAMINO, Shimotsuga (JP); Kosuke ARITA, Kawasaki (JP); Yudai YAMAZAKI, Nasushiobara (JP)

(73) Assignees: Canon Medical Systems Corporation, Otawara-shi (JP); CANON KABUSHIKI KAISHA, Tokyo (JP)

(21) Appl. No.: 19/216,852

(22) Filed: May 23, 2025

(30) Foreign Application Priority Data
Jun. 4, 2024 (JP) 2024-090530

(51) Int. Cl. G06V 20/69; G06T 7/00; G06T 7/62

(52) U.S. Cl. CPC G06V 20/698; G06T 7/0012; G06T 7/62; G06V 20/695; G06T 2207/30024

(57) ABSTRACT

According to one embodiment, an information processing device includes an image acquisition unit, an estimation unit, and a calculation unit. The image acquisition unit acquires a bright field image that captures a cell group including cells of a plurality of types. Based on the bright field image, the estimation unit estimates a specific cell quantity regarding a quantity of cells of a specific type among the plurality of types. Based on the specific cell quantity, the calculation unit calculates a seeding quantity of cells or suspension including the cell of the specific type to be used in the following process.

### CROSS-REFERENCE TO RELATED APPLICATIONS

This application is based upon and claims the benefit of priority from Japanese Patent Application No. 2024-090530, filed Jun. 4, 2024, the entire contents of which are incorporated herein by reference.

### FIELD

Embodiments disclosed in the present specification and the drawings relate to an information processing device, a cell processing apparatus, a seeding cell quantity determination method, and a cell processing method.

### BACKGROUND

With the progress of regenerative medicine, there have been proposed apparatuses for producing pluripotent stem cells from CD34 positive cells. Such an apparatus has been demanded for a simpler and lower-cost production process, and stable acquisition of the certain number of pluripotent stem cells. Consequently, there has been a demand for an inexpensive and simple method to highly accurately estimate a proportion of CD34 positive cells to be seeded and to adjust the number of cells to be seeded.

### BRIEF DESCRIPTION OF THE DRAWINGS

FIG. 1 is a diagram illustrating an example configuration of a cell processing apparatus according to a first embodiment.

FIG. 2 is a diagram schematically illustrating a procedure of cell processing according to the first embodiment.

FIG. 3 is a diagram illustrating an example configuration of an information processing device according to the first embodiment.

FIG. 4 is a diagram illustrating a method for generating a machine learning model according to the first embodiment, and input and output to and from the machine learning model.

FIG. 5 is a diagram schematically illustrating a procedure of processing for calculating performance indexes of the machine learning model according to the first embodiment.

FIG. 6 is a diagram illustrating a confusion matrix regarding the calculation of the performance indexes of the machine learning model according to the first embodiment.

FIG. 7 is a diagram schematically illustrating procedure of cell processing that is performed on cells of a specific type according to the first embodiment.

FIG. 8 is a diagram schematically illustrating a procedure of processing for calculating a seeding quantity according to the first embodiment.

FIG. 9 is a diagram illustrating an example of a method for calculating the seeding quantity according to the first embodiment.

FIG. 10 is a diagram illustrating a display screen according to the first embodiment.

FIG. 11 is a diagram schematically illustrating a procedure of cell processing according to a second embodiment that is performed on cells of a specific type.

FIG. 12 is a diagram schematically illustrating input and output that are performed by a machine learning model according to a modification.

### DETAILED DESCRIPTION

An information processing device according to embodiments includes an image acquisition unit, an estimation unit, and a calculation unit. The image acquisition unit acquires a bright field image that captures a cell group including cells of a plurality of types. Based on the bright field image, the estimation unit estimates a specific cell quantity regarding a quantity of cells of a specific type among the plurality of types. Based on the specific cell quantity, the calculation unit calculates a seeding quantity of cells or suspension including the cells of the specific type to be used in the following process.

Various Embodiments will be described hereinafter with reference to the accompanying drawings.

### First Embodiment

The cell processing apparatus according to a first embodiment is an apparatus for processing a sample to produce pluripotent stem cells derived from a donor (subject) of the sample, from tissue stem cells contained in the sample. The pluripotent stem cells according to the present embodiment include Embryonic Stem(ES) Cells, nuclear transfer Embryonic Stem (ntES) Cells, and induced Pluripotent Stem (iPS) Cells, and other pluripotent stem cells. Artificial pluripotent stem cells are also referred to as induced pluripotent stem cells. Tissue stem cells are cells having pluripotency, such as hematopoietic stem cells, neural stem cells, hepatic stem cells, renal stem cells, and skin stem cells. The samples may be blood, bone marrow, skin, and any other tissues of the donor, and donors include humans and animals.

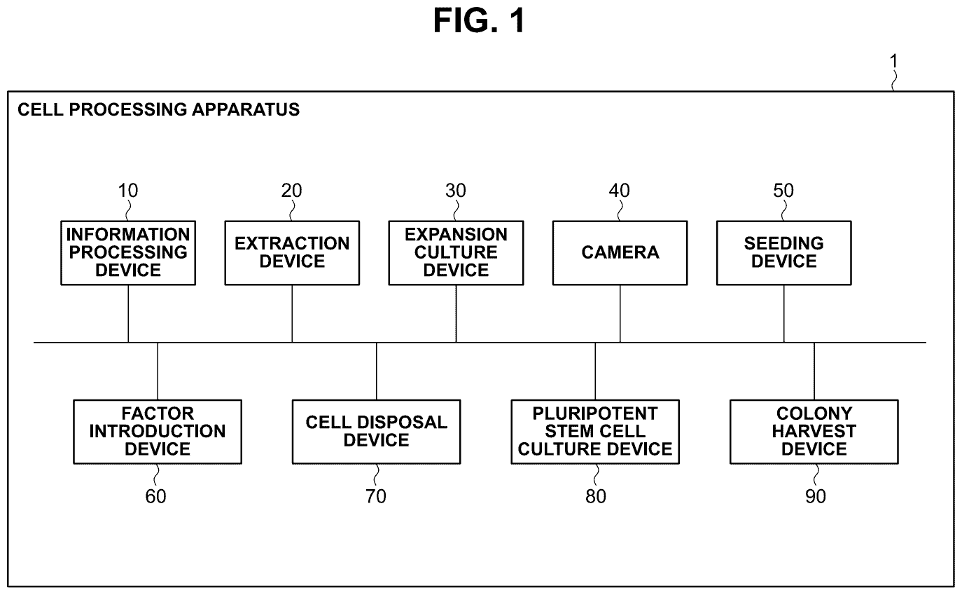

FIG. 1 is a diagram illustrating an example configuration of a cell processing apparatus 1 according to the present embodiment. The cell processing apparatus 1 includes an information processing device 10, an extraction device 20, an expansion culture device 30, a camera 40, a seeding device 50, a factor introduction device 60, a cell disposal device 70, a pluripotent stem cell culture device 80, and a colony harvest device 90. The cell processing apparatus 1 according to the present embodiment is implementable as long as the cell processing apparatus 1 includes at least the information processing device 10, the camera 40, and the seeding device 50.

The extraction device 20 is a mechanical apparatus that extracts a cell group including cells of a plurality of types from the sample of the donor. The cell group includes, for example, human Peripheral Blood Mononuclear Cells (PBMC). Examples of devices applicable as the extraction device 20 include a filtering device and a centrifugal separator.

The expansion culture device 30 is a mechanical apparatus that cultures cells of a specific type among cells of a plurality of types. Examples of cells of the specific type include CD34 positive cells. Cells of specific types may be other tissue stem cells. The expansion culture device 30 includes, for example, a culture vessel and a dispensing mechanism. The dispensing mechanism sucks a suspension containing cells of the specific type and discharges the suspension in the culture vessel. Various reagents, such as a certain culture medium, are added to the culture vessel by the dispensing mechanism. The dispensing mechanism may be implemented by a pump and a nozzle. The expansion culture device 30 may include a plurality of culture vessels. The plurality of culture vessels may be identical or different in size.

The camera 40 captures a bright field image of a cell group including cells of the specific type. A bright field image is an image in which a sample placed between an irradiation light source and the camera 40 is darker than the background. The camera 40 may capture a bright field image in which each cell included in a cell group is countable via a microscope. Instead of using a microscope, the camera 40 may capture a bright field image in which cells of a plurality of types included in a cell group are countable, through high-magnification zoom.

The seeding device 50 is a mechanical apparatus that seeds cells in a culture vessel different from the one used for the expansion culture of cells of the specific type in accordance with the seeding quantity. The seeding quantity refers to volume of seeding suspension including the cells of specific type used to seed the cells of specific type, or refers to the number of cells of a plurality of types to be seeded, the cells of the plurality types including the cells of the specific type. The cells of specific type in the seeding cell suspension or the cells of the plurality types have undergone expansion culture. The seeding suspension refers to a suspension containing cells of the specific type. The seeding device 50 includes, for example, a cell counter and a dispensing mechanism. Examples of methods applicable to the cell counter include the electrical resistance method, the flow cytometry, and/or the cell count method for counting cells based on a bright field image. The dispensing mechanism dispenses a seeding suspension having the seeding quantity to another culture vessel, based on the cell counter. The dispensing mechanism adds various reagents, such as a culture medium, to the culture vessel as appropriate. The dispensing mechanism may be implemented by a pump and a nozzle.

The factor introduction device 60 introduces inducers into cells of a specific type after the expansion culture and establishes pluripotent stem cells. The factor introduction device 60 includes, for example, a dispensing mechanism. The dispensing mechanism dispenses a suspension containing inducers to the culture vessel containing a cell group. The dispensing mechanism may be implemented by a pump and a nozzle. The inducers, also referred to as Yamanaka factors, initialize tissue stem cells. Specific examples of the inducers include the Oct family genes, Klf family genes, and Myc family genes, or the gene products of these genes. For example, Oct3/4 is used as the Oct family genes, Klf4 is used as the Klf family genes, and c-Myc or L-Myc is used as the Myc family genes. Other examples of the inducers include the Sox family genes and the gene products of the genes. Sox2 is used as the Sox family genes. When an inducer is introduced into cells of the specific type, cells of the specific type are initialized, and pluripotent stem cells are established.

The cell disposal device 70 is a mechanical apparatus that disposes of a cell group having been subjected to expansion culture when a predetermined condition is satisfied. The cell disposal device 70 includes, for example, a waste suspension reservoir and a suspension sending mechanism. The suspension sending mechanism sends a cell group to be disposed of to the waste suspension reservoir. The suspension sending mechanism may be implemented by a pump and a nozzle. The waste suspension reservoir is a container for storing a suspension containing disposed cells. The cell disposal device 70 may dispose of various types of suspensions or solutions other than cell groups. For example, the cell disposal device 70 disposes of plasma and mononuclear cells isolated by the extraction device 20, and/or a culture medium and reagents provided to a cell group.

The pluripotent stem cell culture device 80 is a mechanical apparatus that cultures pluripotent stem cells supplied from the factor introduction device 60. More specifically, the pluripotent stem cell culture device 80 includes a culture vessel and a dispensing mechanism. The dispensing mechanism dispenses a suspension containing pluripotent stem cells to the culture vessel. The dispensing mechanism adds various reagents, such as a culture medium, to the culture vessel as appropriate. The dispensing mechanism may be implemented by a pump and a nozzle. The pluripotent stem cell culture device 80 includes at least a first culture vessel. When a predetermined culture period has elapsed, a plurality of cell clumps (colonies) formed of pluripotent stem cells is produced in the culture vessel.

The colony harvest device 90 is a mechanical apparatus that harvests colonies of pluripotent stem cells cultured by the pluripotent stem cell culture device 80, from the culture vessel. More specifically, the colony harvest device 90 includes a storage container and a dispensing mechanism. The dispensing mechanism separates colonies of pluripotent stem cells from the culture vessel and dispenses them to the storage container. To separate colonies of pluripotent stem cells from the culture vessel, the dispensing mechanism adds a solution containing trypsin or Phosphate-Buffered Saline (PBS) to the culture vessel. The dispensing mechanism may be implemented by a pump and a nozzle.

The information processing device 10 is a computer that acquires a bright field image, estimates the specific cell quantity regarding the quantity of cells of the specific type in the cell group based on the bright field image, and calculates the seeding quantity of cells or suspension including the cells of the specific type to be used in the following process, based on the specific cell quantity. The specific cell quantity refers to, for example, a ratio of the number of cells of the specific type to the number of cells of a plurality of types, or the number of cells of a specific type.

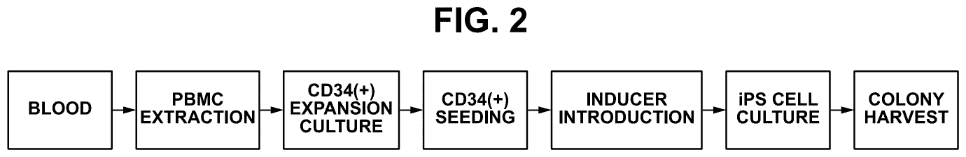

FIG. 2 schematically illustrates an example of processing for producing pluripotent stem cells. As illustrated in FIG. 2, the extraction device 20 extracts PBMC from blood serving as a sample derived from the donor. Then, the expansion culture device 30 subjects CD34 positive cells included in the extracted PBMC to expansion culture to selectively multiply the CD34 positive cells. The factor introduction device 60 introduces an inducer into CD34 positive cells having been subjected to expansion culture to establish pluripotent stem cells from CD34 positive cells. The pluripotent stem cell culture device 80 cultures the established pluripotent stem cells to multiply the CD34 positive cells. The colony harvest device 90 harvests the colonies of pluripotent stem cells adhering to the culture vessel, from the culture vessel to the storage container.

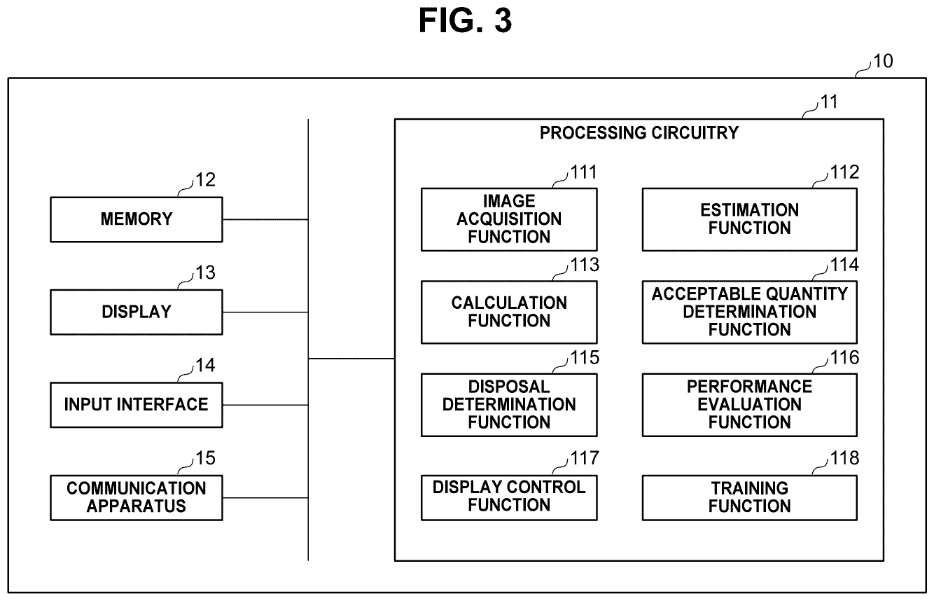

FIG. 3 is a diagram illustrating an example configuration of the information processing device 10 in FIG. 1. As illustrated in FIG. 3, the information processing device 10 includes processing circuitry 11, a memory 12, a display 13, an input interface 14, and a communication device 15. The processing circuitry 11, the memory 12, the display 13, the input interface 14, and the communication device 15 are connected with each other for communication via a bus.

The processing circuitry 11 includes a processor which executes programs according to the present embodiment to implement at least one of an 1 image acquisition function 111, an estimation function 112, a calculation function 113, an acceptable quantity determination function 114, a disposal determination function 115, a performance evaluation function 116, a display control function 117, and a training function 118. The programs are stored in a computer-readable recording medium, such as the memory 12 and a mobile recording medium.

The implementation of the image acquisition function 111 allows the processing circuitry 11 to acquire various types of images. The processing circuitry 11 acquires, for example, a bright field image that captures a cell group including cells of a plurality of types. A cell group having been subjected to expansion culture may be the subject of the bright field image.

The implementation of the estimation function 112 allows the processing circuitry 11 to estimate the specific cell quantity regarding the quantity of cells of the specific type among a plurality of types, based on the bright field image acquired by the image acquisition function 111. The processing circuitry 11 may estimate the specific cell quantity based on the bright field image by using a machine learning model that has been trained by input of bright field images of training data to cause the machine learning model to output a classification result of cells of a specific type captured in the bright field image. Examples of usable machine learning models include a support vector machine, decision tree, ensemble learning, k neighborhood method, and logistic regression for supervised learning, or clustering and principal component analysis for unsupervised learning. Machine learning models may be stored in the memory 12.

The implementation of the calculation function 113 allows the processing circuitry 11 to calculate the seeding quantity of cells or suspension including cells of the specific type to be used in the following process, based on the specific cell quantity. For example, the following process is a process for culturing pluripotent stem cells, based on seeded cells of the specific type. The processing circuitry 11 calculates the seeding quantity further based on performance indexes of the machine learning model. The performance indexes refer to statistics values based on the numbers of true and false values in the classification result obtained by comparison between the classification result output in response to input of a bright field image to a machine learning model and a label associated with the bright field image.

The implementation of the acceptable quantity determination function 114 allows the processing circuitry 11 to determine whether the seeding quantity falls within the acceptable seeding quantity. The acceptable seeding quantity refers to a range of the seeding quantity appropriate for culturing of pluripotent stem cells in the culture vessel in which cells of the specific type are seeded. The seeding quantity refers to the number of cells to be seeded. If the seeding quantity of cells of the specific type is larger than the acceptable seeding quantity, an excessive number of colonies of pluripotent stem cells are formed in the culture vessel which is then covered by immature colonies. On the other hand, if the seeding quantity of cells of the specific type is smaller than the acceptable seeding quantity, the quantity of cells is not reached the required number even after colonies of pluripotent stem cells mature.

The implementation of the disposal determination function 115 allows the processing circuitry 11 to determine whether to dispose of a cell group. For example, in a case where the processing circuitry 11 determines to dispose of a cell group, the processing circuitry 11 sends a signal to dispose of the cell group to the cell disposal device 70 via the communication device 15.

The implementation of the performance evaluation function 116 allows the processing circuitry 11 to evaluate the performance indexes of the machine learning model to correct the seeding quantity to be calculated by the calculation function 113.

The implementation of the display control function 117 allows the processing circuitry 11 to display various information on the display 13. For example, the processing circuitry 11 displays the specific cell quantity estimated by the estimation function 112 and the seeding quantity calculated by the calculation function 113. The processing circuitry 11 also displays information about the disposal of a cell group having been disposed of by the disposal determination function 115.

The implementation of the training function 118 allows the processing circuitry 11 to train an unlearned machine learning model to use the model for the estimation of the specific cell quantity. For example, the processing circuitry 11 trains the unlearned machine learning model by input of bright field images of training data to cause the unlearned machine learning model to output a classification result of cells of the specific type captured in the bright field image.

The memory 12 is a storage device, such as a Random Access Memory (RAM), Read Only Memory (ROM), Hard Disk Drive (HDD), Solid State Drive (SDD), and other semiconductor storage devices, for storing various information. For example, the storage device stores machine learning models and various programs to be used for the estimation function 112. The memory 12 as a hardware component may be a drive device for reading and writing various information from and to a Compact Disc Read Only Memory (CD-ROM) drive, Digital Versatile Disc (DVD) drive, flash memory, and other mobile recording media.

The display 13 displays various information. Examples of displays usable as the display 13 as appropriate include a Cathode Ray Tube (CRT) display, Liquid Crystal Display (LCD), organic Electroluminescence (EL) display, Light Emitting Diode (LED) display, plasma display, and other optional displays known in the relevant technical field. The display 13 may also be a projector.

The input interface 14 is an interface for inputting various instructions from the user. Examples of devices usable as the input interface 14 include a keyboard, mouse, and various switches. The input interface 14 supplies output signals corresponding to various instructions to the processing circuitry 11 via a bus.

The communication device 15 performs wired or wireless data communication with the extraction device 20, the expansion culture device 30, the camera 40, the seeding device 50, the factor introduction device 60, the cell disposal device 70, the pluripotent stem cell culture device 80, and/or the colony harvest device 90. For example, the communication device 15 receives bright field images from the camera 40. The communication device 15 sends the seeding quantity calculated by the calculation function 113 to the seeding device 50.

A machine learning model according to the first embodiment will be described in detail below.

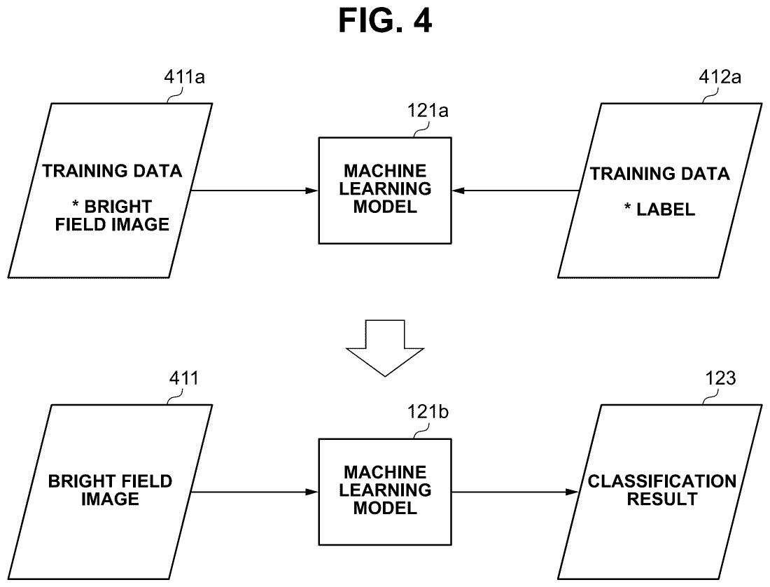

FIG. 4 is a diagram illustrating a method for training a machine learning model, and input and output to and from the model. The upper drawing of FIG. 4 illustrates a method for training a machine learning model 121a that is to be trained. The lower drawing of FIG. 4 illustrates input and output to and from a machine learning model 121b that has been trained. As illustrated in the lower drawing of FIG. 4, the machine learning model 121b receives input of a bright field image 411 and outputs a classification result 123 of cells of the specific type captured in the bright field image 411. More specifically, the classification result 123 indicates whether the cells captured in the bright field image 411 are cells of the specific type. For example, the classification result 123 is defined to be “1” in a case where the subject of the bright field image 411 input to the machine learning model 121b is cells of the specific type, or “0” in a case where the subject is not cells of the specific type. For another example, the classification result 123 is defined to be the number of cells of the specific type in a case where the subject of the bright field image 411 input to the machine learning model 121b includes a plurality of cells of the specific type.

For example, the machine learning model 121b classifies whether one cell captured in one bright field image is a cell of the specific type. The machine learning model 121b classifies whether the cell is a cell of the specific type by using form information and luminance information captured in the bright field image 411 as feature quantities. The form information represents the outer shape of a cell. The luminance information represents the luminance of pixels representing the thickness of the cell. Using the machine learning model 121b to classify cells of the specific type leads to reduction in variations due to manual procedures and also leads to reduction in human operations, which results in reduction in cost.

A machine learning model that has learned may output a plurality of classification results in response to input of a plurality of bright field images. In response to input of a bright field image, a machine learning model may output the specific cell quantity regarding the bright field image. More specifically, the machine learning model calculates a classification result in response to an input of the bright field image. The machine learning model outputs the specific cell quantity, based on the calculated classification result. For example, the machine learning model outputs the number of classification results of cells classified as of the specific type, as the specific cell quantity. In this case, the specific cell quantity indicates the number of cells of the specific type. For another example, the machine learning model outputs the ratio of the number of classification results of cells classified as of the specific type to the total number of classification results, as the specific cell quantity. In this case, the specific cell quantity indicates the ratio of the number of cells of the specific type to the number of cells of a plurality of types.

As illustrated in the upper drawing of FIG. 4, the implementation of the training function 118 allows the processing circuitry 11 to train parameters for defining the output in response to input of an unlearned machine learning model 121a to output the classification result 123 from a bright field image 411a. In this case, the processing circuitry 11 uses supervised learning based on, as training data, the bright field image 411a including cells of the specific type. The training data includes the bright field image 411a, and a label 412a indicating whether the bright field image 411a includes cells of the specific type. The label 412a is associated with the bright field image 411a by using a fluorescence image. In the fluorescence image, almost the same cells as those in the bright field image 411a serving as training data are captured, and cells of the specific type among these cells are subjected to fluorescent dyeing.

As for an unlearned machine learning model, the parameters may be trained by using unsupervised learning based on a bright field image that captures cells of the specific type as training data. In this case, the processing circuitry 11 trains the parameters of the unlearned machine learning model to cause the machine learning model to output the specific cell quantity based on a bright field image that has no associated label as training data.

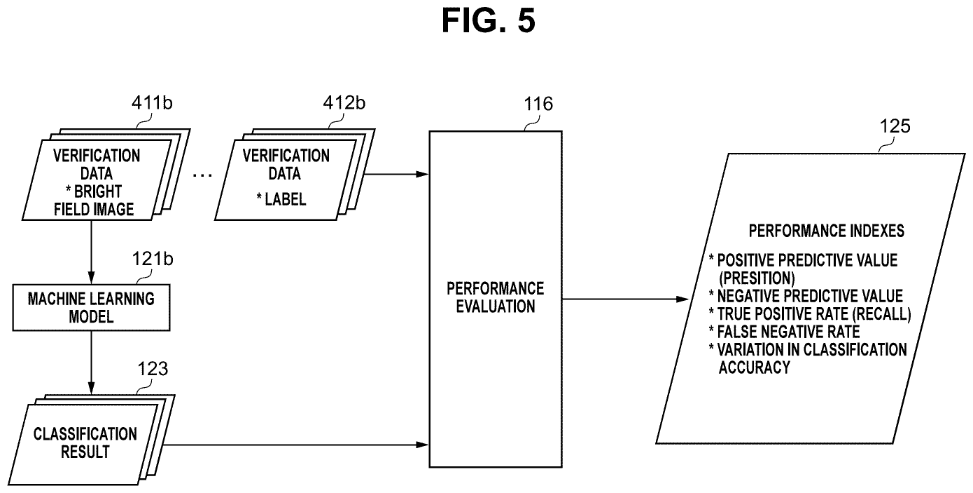

FIG. 5 illustrates an example of processing for acquiring performance indexes 125 of the machine learning model 121b. As illustrated in FIG. 5, the implementation of the performance evaluation function 116 allows the processing circuitry 11 to calculate the performance indexes 125 based on a plurality of the classification results 123 output in response to input of, as verification data, a plurality of the bright field images 411b different from the training data to the machine learning model 121b, and a plurality of labels 412b each associated with a different one of the plurality of the bright field images 411b as verification data.

For example, the processing circuitry 11 divides the plurality of classification results 123 output in response to input of the plurality of the bright field images 411b as verification data to the machine learning model 121b, into four different sets, based on the plurality of the labels 412b each associated with a difference one of the plurality of the bright field images 411b. A first set is a set in which the bright field images 411b associated with the labels 412b of cells of the specific type are classified as cells of the specific type. A second set is a set in which the bright field images 411b associated with the labels 412b of cells of the specific type are classified as cells other than cells of the specific type. A third set is a set in which the bright field images 411b associated with the labels 412b of cells other than cells of the specific type are classified as cells of the specific type. A fourth set is a set in which the bright field images 411b associated with the labels 412b of cells other than cells of the specific type are classified as cells other than cells of a specific type. The processing circuitry 11 calculates the performance indexes 125 by performing statistical analysis using the number of elements of each of the four sets.

The performance indexes are not limited to indexes obtained as a result of evaluating a learned machine learning model. The performance indexes 125 are acquired in accordance with the technique that is to be used in the estimation function 112 to classify cells of the specific type.

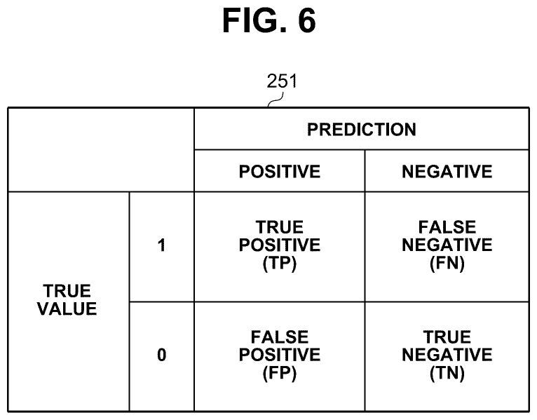

FIG. 6 is a diagram schematically illustrating a confusion matrix 251 regarding the classification of cells of the specific type of the machine learning model. The rows of the confusion matrix 251 illustrated in FIG. 6 indicate whether a cell is of the specific type. The processing circuitry 11 may determine whether the cell is of the specific type based on the label 412b. The row of “1” indicates the number of cells labeled as cells of the specific type. The row of “0” indicates the number of cells labeled as cells not of the specific type. The columns of the confusion matrix 251 indicate whether the machine learning model classifies the cell is of the specific type. The determination of whether the cell is of the specific type may be performed based on classification result. The column of “Positive” indicates the number of cells classified as cells of the specific type by the machine learning model. The column of “Negative” indicates the number of cells classified as cells not of the specific type by the machine learning model.

The confusion matrix 251 illustrated in FIG. 6 is divided into four different sets: true positive (TP), false negative (FN), false positive (FP), and true negative (TN). The true positive number corresponds to the number of elements of the first set. The false negative number corresponds to the number of elements of the second set. The false positive number corresponds to the number of elements of the third set. The true negative number corresponds to the number of elements of the fourth set. The processing circuitry 11 calculates the performance indexes by using the four sets of the confusion matrix 251. Examples of the performance indexes include a positive predictive value (precision and accuracy), a negative predictive value, a true positive rate (recall), a false negative rate, a false positive rate, true negative rate, degree of accuracy (correct answer factor), F value, an error between the true value and the estimated value, and deviation. For example, the processing circuitry 11 calculates the positive predictive value as a performance index by calculating TP/(TP+FP). For another example, the processing circuitry 11 calculates the negative predictive value as a performance index by calculating TN/(TN+FN). The performance indexes may include a plurality of statistics values.

The cell processing procedures from the expansion culture of CD34 positive cells to the introduction of the inducers illustrated in FIG. 2 will be described in detail below.

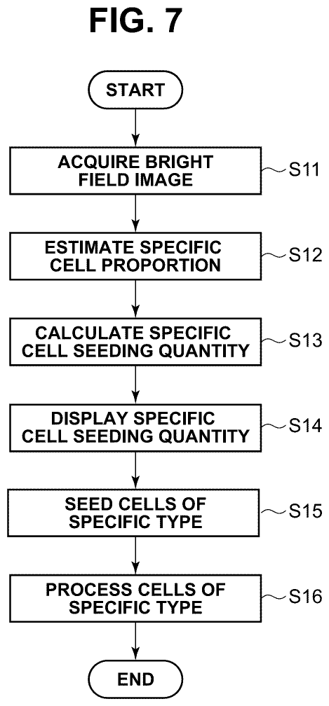

FIG. 7 schematically illustrates procedures of cell processing that is performed on cells of the specific type by the cell processing apparatus 1 according to the first embodiment. As illustrated in FIG. 7, in step S11, the implementation of the image acquisition function 111 allows the processing circuitry 11 to acquire a bright field image that captures a cell group including cells of a plurality of types. A cell group including cells of a plurality of types includes, for example, PBMC. The bright field image according to the first embodiment may be captured by the camera 40 capturing a cell group having been subjected to the expansion culture by the expansion culture device 30.

The bright field image is not limited to an image acquired via the camera 40. The bright field image may be acquired, for example, via the communication device or the memory 12. For example, the processing circuitry 11 acquires a bright field image that captures a plurality of cells, and generates a bright field image that captures a single cell by using an image analysis technique, such as object detection.

After completion of step S11, then in step S12, the implementation of the estimation function 112 enables the processing circuitry 11 to estimate the specific cell quantity regarding the quantity of cells of the specific type, based on the bright field image acquired in step S11. For example, the processing circuitry 11 totals the classification results output in response to input of a plurality of bright field images to the machine learning model as described above, and estimates the specific cell quantity. By estimating the specific cell quantity in a noninvasive way by using a bright field image, damages to cells of the specific type can be further reduced than a case using a fluorescence image. In addition, by not providing a device for subjecting cells of the specific type to fluorescent dyeing, components of the cell processing apparatus 1 is simplified, which leads to cost effective production of pluripotent stem cells.

The machine learning model may output the specific cell quantity in response to input of a bright field image. In this case, the machine learning model may perform processing for outputting the specific cell quantity estimated by using a classification result obtained in response to input of a bright field image.

After completion of step S12, then in step S13, the implementation of the calculation function 113 allows the processing circuitry 11 to calculate the seeding quantity of cells or suspension including the cells of the specific type to be used in the following process, based on the specific cell quantity estimated in step S12. The following process includes, for example, the seeding of cells in the culture vessel of the pluripotent stem cell culture device 80. The seeding suspension is, for example, a cell suspension adjusted by a cell group and a culture medium.

More specifically, the processing circuitry 11 calculates the seeding quantity based on the specific cell quantity and the performance indexes of the machine learning model.

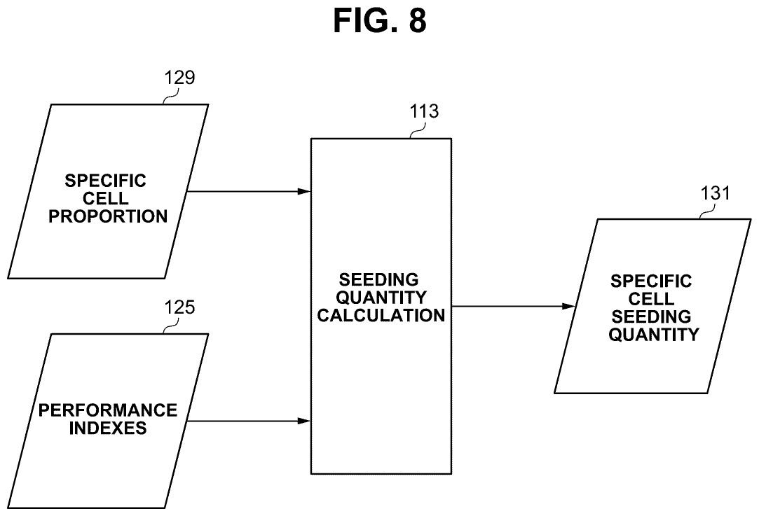

FIG. 8 is a diagram illustrating an example of processing for calculating a seeding quantity 131. As illustrated in FIG. 8, the processing circuitry 11 calculates the seeding quantity 131 based on a specific cell quantity 129 and the performance indexes 125. Since the seeding quantity 131 is calculated based on the performance indexes 125 in addition to the specific cell quantity 129, an error derived from the machine learning model is reduced.

Three different methods for calculating the seeding quantity based on the correlation between the ratio of the number of CD34 positive cells to the number of seeding cells and the colony forming rate of iPS cells will be described with reference to formulas. The colony forming rate refers to the ratio of the number of colonies (described below) divided by the seeding cell number for cells of a plurality of types.

As a first calculation method, the seeding quantity based on a bright field image is represented by the following Formula (1).

$$N = \frac{X}{Y \times a} \qquad ( 1 )$$

Formula (1) calculates the seeding quantity based on the number of colonies of pluripotent stem cells, the specific cell quantity, the establishment rate of pluripotent stem cells. X denotes the number of colonies of pluripotent stem cells. The number of colonies of pluripotent stem cells refers to the target number of colonies of pluripotent stem cells to be cultured by the cell processing apparatus 1. For the number of colonies of pluripotent stem cells, a predetermined numerical value associated with a protocol may be input, or a numerical value desired by the user may be input according to a user instruction. Y denotes the specific cell quantity estimated by the processing circuitry 11 based on a bright field image. The specific cell quantity may be the ratio of the number of cells of the specific type to the number of cells of a plurality of types subjected to the expansion culture. The establishment rate of pluripotent stem cells is denoted by a. The establishment rate of pluripotent stem cells refers to the ratio of the number of pluripotent stem cells, which is to be obtained as a result of introducing inducers to cells of the specific type, to the number of cells of the specific type. The establishment rate may be determined on an experimental basis, or a known value in a document may be used. N denotes the seeding quantity as the number of cells of a plurality of types. Using Formula (1) enables easily calculating the seeding quantity corresponding to the target number of colonies of pluripotent stem cells to be cultured.

As a second calculation method, the seeding quantity based on a bright field image and the performance indexes including a single statistics value is represented by the following Formula (2).

$$N = \frac{X}{Y \times PPV \times a} \qquad ( 2 )$$

Formula (2) calculates the seeding quantity based on the number of colonies of pluripotent stem cells, the specific cell quantity, the establishment rate of pluripotent stem cells, and the positive predictive value. X, Y, and a are similar to those of Formula (1). PPV denotes the positive predictive value as one of the performance indexes.

Using Formula (2) enables calculating the seeding quantity corrected with the performance indexes of the machine learning model.

As a third calculation method, the seeding quantity based on the bright field image and the performance indexes 125 including a plurality of statistics values is represented by the following Formula (3).

$$N = \frac{X}{( Y \times PPV + ( 1 - Y ) \times ( 1 - PNV ) ) \times a} \qquad ( 3 )$$

Formula (3) calculates the seeding quantity based on the number of colonies of pluripotent stem cells, the specific cell quantity, the establishment rate of the pluripotent stem cells, the positive predictive value, and the negative predictive value. X, Y, a, and PPV are similar to those of Formula (2). PNV denotes the negative predictive value as one of performance indexes. Using Formula (3) enables calculating the seeding quantity with a higher accuracy than using Formula (2) because the seeding quantity is corrected by a plurality of statistics values.

In a case where the seeding quantity is calculated as the volume of a seeding suspension containing a cell group, the seeding quantity may be calculated by dividing N of Formulas (1) to (3) by the cell density of the sample cell group. More specifically, the seeding quantity is represented by the following Formula (4).

$$v = \frac{N}{c} \qquad ( 4 )$$

N denotes the number of seeding cells of a plurality of types. N in Formula (4) may be N calculated in Formulas (1) to (3). V denotes the seeding quantity calculated as the volume of the seeding suspension containing a cell group. The cell density of the cell group is denoted by c which indicates the number of cells of a plurality of types with respect to the volume of a culture suspension of the culture medium where the cell group is cultured. The cell density may be calculated by using the cell counter or based on the acquired bright field image. Since the seeding quantity is calculated as the volume of the seeding suspension, cells are easily seeded without counting the number of cells of the specific type.

The processing circuitry 11 may calculate the seeding quantity based on the specific cell quantity, the target number of colonies of pluripotent stem cells to be cultured, and the first acceptable seeding quantity based on the size of the first culture vessel to be subjected to the seeding of cells of the specific type.

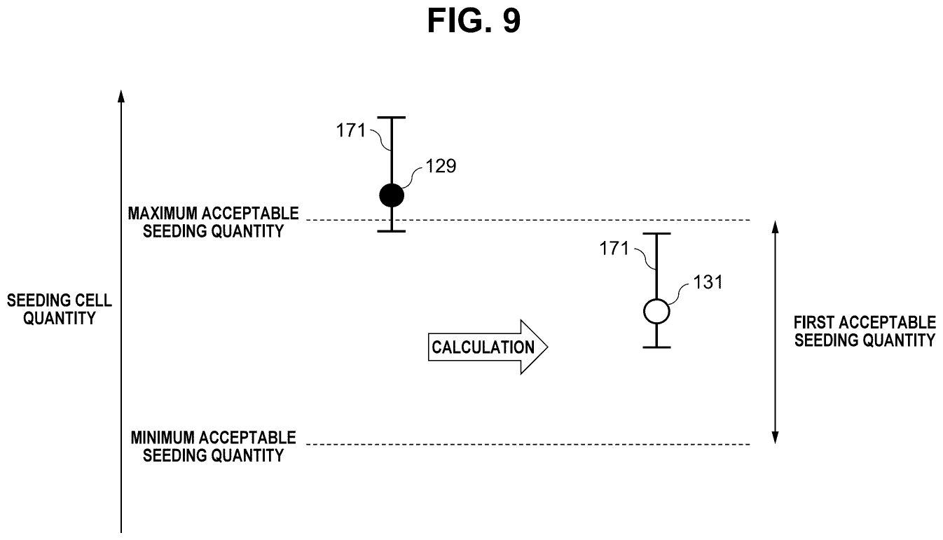

FIG. 9 is a diagram schematically illustrating an example of calculation of the seeding quantity 131 based on the specific cell quantity 129, the target number of colonies of pluripotent stem cells to be cultured, and the first acceptable seeding cell quantity. The vertical axis represents the seeding cell quantity as the number of cells of the specific type to be seeded. As illustrated in FIG. 9, the first acceptable seeding quantity refers to a range of the number of cells of the specific type from the minimum acceptable seeding quantity as the lower limit to the maximum acceptable seeding quantity as the upper limit. For example, the maximum acceptable seeding quantity is determined based on the number of cells of the specific type over which leads to an excessive number of immature colonies of pluripotent stem cells formed on the surface of the culture vessel. The minimum acceptable seeding cell quantity is determined based on the number of cells of a specific type under which leads to an insufficient number of colonies of pluripotent stem cells less than the target culture number.

The seeding quantity 131 is calculated based on the specific cell quantity 129 and the performance indexes. For example, as illustrated in FIG. 9, the performance indexes are used as an error bar 171 of the specific cell quantity 129. More specifically, the error bar 171 extending in a direction in which the seeding cell quantity of the specific cell quantity 129 increases may be determined by the positive correlation with the false positive value. The error bar 171 extending in a direction in which the seeding cell quantity of the specific cell quantity 129 decreases may be determined by the positive correlation with the false negative value. The seeding quantity 131 is calculated to be the seeding cell quantity in such a manner that the specific cell quantity 129 including the error bar 171 is included in the first acceptable seeding quantity. The error bar 171 may be determined by using the performance indexes including one statistics value. For example, for the specific cell quantity 129, the performance indexes including one statistics value, such as the degree of accuracy or precision may be used to determine the error bar 171. In this case, the error bar 171 determined has approximately the same length in the directions in which the seeding cell quantity increases and decreases. By calculating the seeding quantity 131 based on the first acceptable seeding quantity, the seeding quantity 131 suitable for the size of the first culture vessel is obtained.

The acceptable seeding quantity illustrated in FIG. 9 may be applied to the specific cell quantity 129 as the number of cells of the specific type calculated by Formulas (1) to (3). The seeding quantity 131 as the volume of the seeding suspension containing cells of the specific type may also be calculated by applying Formula (4) to the seeding quantity 131 which is the number of cells of the specific type calculated by using the method illustrated in FIG. 9.

After completion of step S13, then in step S14, the implementation of the display control function 117 allows the processing circuitry 11 to display the specific cell quantity estimated in step S12 and/or the seeding quantity calculated in step S13 on the display 13.

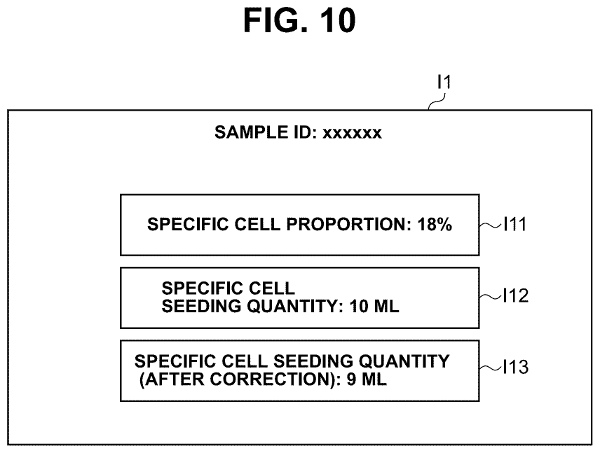

FIG. 10 illustrates an example of a display screen I1 displaying the specific cell quantity and the seeding quantity displayed in step S14. The display screen I1 is displayed on the display 13. As illustrated in FIG. 10, an identifier (ID) indicating identification information on the sample donor or the sample is displayed on the display screen I1. The display screen I1 also displays display fields 111, 112, and I13. The display field I11 displays the specific cell quantity estimated in step S12. The display field 112 displays the seeding quantity calculated without using the performance indexes in step S13. The display field I13 displays the seeding quantity calculated by using the performance indexes in step S13. By displaying the specific cell quantity or the seeding quantity on the display screen I1, the user can be notified of the output of the information processing device 10. In addition, the seeding quantity calculated without using the performance indexes and the seeding quantity corrected by using the performance indexes may be displayed together, so that the user can compare the presence or absence of the correction of the performance indexes.

The display field I11 may display the specific cell quantity as the number of cells of the specific type. The display fields 112 and I13 may display the seeding quantity as the number of cells of the specific type. Further, the display fields I12 and I13 indicating the seeding quantity in the display screen I1 in FIG. 10 may be displayed to be selectable. For example, the seeding quantity is determined to be a value selected according to a user instruction. This allows the user to adjust the seeding quantity. The information displayed on the display screen I1 is not limited to the above-described information. For example, the display screen I1 may also display information about the sample before the expansion culture.

After completion of step S14, then in step S15, the seeding device 50 seeds cells of the specific type in the seeding quantity calculated in step S13 from the cell group having been subjected to the expansion culture. For example, the seeding device 50 sends the seeding suspension containing cells of the specific type in the seeding quantity from the expansion culture device 30 to the culture vessel. By seeding cells of the specific type according to the seeding quantity, cells of the specific type in the seeding quantity appropriate for obtaining the required number of colonies of pluripotent stem cells is able to be seeded. In a case where the seeding quantity is calculated as the volume of the seeding suspension, the seeding device 50 may send the seeding suspension in the seeding quantity from the expansion culture device 30 to the culture vessel.

After completion of step S15, then in step S16, the cell processing apparatus 1 processes cells of the specific type seeded in step S15. For example, the cell processing apparatus 1 introduces inducers into seeded cells of the specific type via the factor introduction device 60 to establish pluripotent stem cells. Examples of usable gene introduction methods include the viral vector method and the electroporation method. Usable gene introduction methods are not limited to the above-described methods. The cell processing apparatus 1 can introduce genes by using any possible methods involving a small variation in the establishment rate.

After completion of step S16, the processing circuitry 11 ends processing of cells of the specific type according to the first embodiment.

The procedures of cell processing on cells of the specific type by the cell processing apparatus 1 illustrated in FIG. 7 are illustrative and can be subjected to deletion, addition, and/or modification in diverse ways without departing from the spirit and scope of the present invention. For example, the introduction of the inducers in step S16 may be performed before the seeding of cells of the specific type, in other words, before step S15. In the step S15, the cell processing apparatus 1 may culture the established pluripotent stem cells via the pluripotent stem cell culture device 80. Further, based on the disposal determination, the cell processing apparatus 1 may dispose of a cell group via the cell disposal device 70 or harvest colonies of cultured pluripotent stem cells via the colony harvest device 90.

Further, the specific cell quantity regarding the number of included differentiated pluripotent stem cells among cells of a plurality of types may be estimated. For example, the implementation of the calculation function 113 allows the processing circuitry 11 to calculate the seeding quantity regarding the quantity of subculture cells of differentiated pluripotent stem cells. This enables estimating the proportion of undifferentiated pluripotent stem cells among the induced differentiated pluripotent stem cells, the number of undifferentiated pluripotent stem cells, and/or the number of differentiated pluripotent stem cells.

According to the first embodiment, by estimating the specific cell quantity in a noninvasive way, the loss of cells of the specific type is reduced, which allows control of the number of cells of the specific type as live cells to be seeded. Further, by using the performance indexes that are evaluations of the estimation accuracy obtained using a bright field image, cells of the specific type in the seeding quantity appropriate to obtain the required number of colonies of pluripotent stem cells is able to be seeded.

### Second Embodiment

With the cell processing apparatus 1 according to the first embodiment, cells of the specific type are seeded in one culture vessel. With a cell processing apparatus 1 according to a second embodiment, cells of the specific type are seeded in a culture vessel having the size corresponding to the specific cell quantity. The cell processing apparatus 1 according to the second embodiment will be described below. Components having the same function as those according to the first embodiment are assigned the same reference numerals, and the redundant descriptions are provided only when necessary.

According to the second embodiment, the pluripotent stem cell culture device 80 includes the first culture vessel and a second culture vessel smaller than the first culture vessel in size.

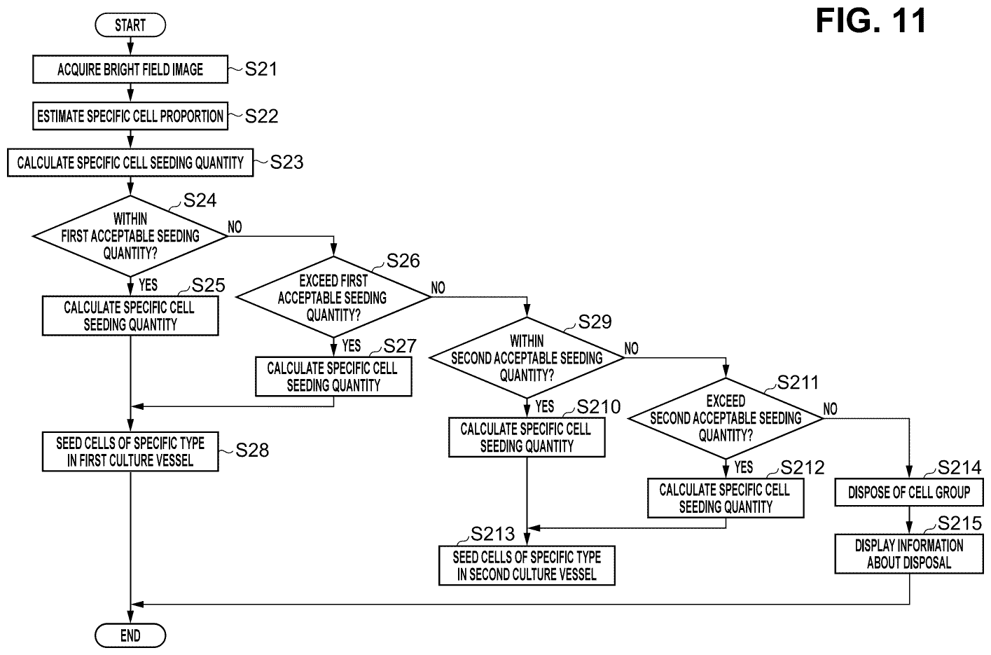

FIG. 11 schematically illustrates procedures of cell processing on cells of the specific type by the cell processing apparatus 1 according to the second embodiment. Steps S21 to S23 illustrated in FIG. 11 are similar to steps S11 to S13 illustrated in FIG. 7, respectively.

After completion of step S23, then step S24, the implementation of the acceptable quantity determination function 114 allows the processing circuitry 11 to determine whether the specific cell quantity is within the first acceptable seeding quantity. For example, the processing circuitry 11 determines whether the specific cell quantity 129 and the error bar 171 illustrated in FIG. 9 fall within a first acceptable range. More specifically, in a case where the difference between the maximum value of the specific cell quantity including the error bar 171 and the maximum seeding quantity of the first acceptable seeding quantity is negative, and the difference between the minimum value of the specific cell quantity including the error bar 171 and the minimum seeding quantity of the first acceptable seeding cell quantity is positive, the specific cell quantity is determined to fall within the first acceptable seeding quantity.

In a case where the specific cell quantity is determined to be within the first acceptable seeding quantity (YES in step S24), then in step S25, the implementation of the calculation function 113 allows the processing circuitry 11 to calculate the total of the cell group as the seeding quantity. The processing circuitry 11 may calculate the seeding quantity so as to be a number less than the cell group in the range where the seeding quantity is within the first acceptable seeding quantity. In this case, the seeding quantity may be calculated to be a number less than the cell group in the range where the seeding quantity is within the first acceptable seeding quantity. For example, the implementation of the display control function 117 allows the processing circuitry 11 to display the first acceptable seeding quantity that can be set by the user, before the calculation of the seeding quantity. The processing circuitry 11 calculates the seeding quantity in accordance with a user instruction via the input interface 14.

In a case where the specific cell quantity is determined to be not within the first acceptable seeding quantity (NO in step S24), then in step S26, the implementation of the acceptable quantity determination function 114 allows the processing circuitry 11 to determine whether the specific cell quantity exceeds the first acceptable seeding quantity. For example, in a case where the difference between the maximum value of the specific cell quantity including the error bar 171 and the maximum seeding quantity of the first acceptable seeding quantity is positive, the specific cell quantity is determined to exceed the first acceptable seeding quantity.

In a case where the specific cell quantity is determined to exceed the first acceptable seeding quantity (YES in step S26), then in step S27, the implementation of the calculation function 113 allows the processing circuitry 11 to calculate the seeding quantity less than the total of the cell group in such a manner that the seeding quantity falls within the first acceptable seeding quantity.

After completion of step S25 or S27, then in step S28, the seeding device 50 seeds cells of the specific type corresponding to the seeding quantity in the first culture vessel. The implementation of the disposal determination function 115 allows the processing circuitry 11 to determine to dispose of a cell group not having been seeded in the first culture vessel. Based on the determination of the disposal, the cell disposal device 70 may dispose of a cell group not having been seeded in the first culture vessel.

In a case where the specific cell quantity is determined to not exceed the first acceptable seeding quantity (NO in step S26), then in step S29, the implementation of the acceptable quantity determination function 114 allows the processing circuitry 11 to determine whether the specific cell quantity is within a second acceptable seeding quantity. The second acceptable seeding quantity refers to the second acceptable quantity corresponding to the second culture vessel. For example, the maximum acceptable seeding quantity of the second acceptable seeding quantity is set to be smaller than that of the first acceptable seeding quantity. The determination may be performed for the second acceptable seeding quantity in processing similar to step S24.

In a case where the specific cell quantity is determined to be within the second acceptable seeding quantity (YES in step S29), then in step S210, the implementation of the calculation function 113 allows the processing circuitry 11 to calculate the total of the cell group as the seeding quantity. The processing circuitry 11 may calculate the seeding quantity as a number less than the cell group in the range where the seeding quantity is within the first acceptable seeding quantity.

In a case where the specific cell quantity is determined to be not within the second acceptable seeding cell quantity (NO in step S29), then in step S211, the implementation of the acceptable quantity determination function 114 allows the processing circuitry 11 to determine whether the specific cell quantity exceeds the second acceptable seeding quantity. For example, the condition to determine whether to dispose of a cell group of the cell processing apparatus 1 according to the second embodiment is whether the specific cell quantity falls below the second acceptable seeding quantity. In a case where the specific cell quantity falls below or does not exceed the second acceptable seeding quantity (NO in step S211), then in step S214, the implementation of the disposal determination function 115 allows the processing circuitry 11 to determine, based on the volume of the culture medium containing the cell group or a user instruction, to dispose of the cell group.

In a case where the specific cell quantity is determined to exceed the second acceptable seeding quantity (YES in step S211), then in step S212, the implementation of the calculation function 113 allows the processing circuitry 11 to calculate the seeding quantity less than the total of the cell group in such a manner that the seeding quantity is within the second acceptable seeding quantity.

After completion of step S210 or S212, then in step S213, the seeding device 50 seeds cells of the specific type corresponding to the seeding quantity in the second culture vessel. This enables improving the efficiency of producing pluripotent stem cells from a cell group of which quantity is less than the first acceptable seeding quantity. The implementation of the disposal determination function 115 may allow the processing circuitry 11 to determine to dispose of the cell group not having been seeded in the second culture vessel. Based on the determination of the disposal, the cell disposal device 70 may dispose of the cell group not having been seeded in the second culture vessel.

In a case where the specific cell quantity is determined to not exceed the second acceptable seeding quantity (NO in step S211), then in step S214, the cell disposal device 70 disposes of the cell group. For example, the cell disposal device 70 disposes of the cell group by sending the cell group from the expansion culture device 30 to the waste suspension reservoir of the cell disposal device 70. The disposal of the cell group not satisfying the suitable condition for producing pluripotent stem cells enables improving the efficiency of producing pluripotent stem cells.

After completion of step S214, then in step S215, the implementation of the display control function 117 allows the processing circuitry 11 to display information about the disposal of the cell group on the display 13. The displayed information about the disposal of a cell group includes, for example, a message indicating the disposal of the cell group, the reason for disposing of the cell group, the date and time of disposal of the cell group, and information for identifying the disposed cell group. More specifically, the message indicating the disposal of the cell group may be a character string such as “Cell group has been disposed of”. The reason for disposing of the cell group may be a character string such as “Due to less than second acceptable seeding quantity”. The information for identifying the disposed cell group may be the ID of the sample or the name of the sample donor. Displaying the information about the disposal of the cell group on the display 13 enables the user to be notified of the information about the disposal of the cell group.

The information about the disposal of the cell group may be displayed before disposing of the cell group. In this case, for the information about the disposal of the cell group, the display screen I1 may include a display field selectable for the user to determine whether to dispose of the cell group according to a user instruction. The display field for determination of the disposal of the cell group may include a character string such as “Dispose of cell group”. The display field for determination to continue the culture of the cell group may include a character string such as “Maintain cell group culturing”. The disposal of the cell group may be determined based on a user instruction.

After completion of step S215, the processing circuitry 11 ends processing of cells of the specific type according to the second embodiment.

The procedures of cell processing on cells of the specific type by the cell processing apparatus 1 illustrated in FIG. 11 is illustrative and can be subjected to deletion, addition, and/or modification in diverse ways without departing from the spirit and scope of the present invention. For example, the processing in steps S24 and S25 and the processing in steps S26 and S27 may be exchanged. Likewise, the processing in steps S29 and S210 and the processing in steps S211 and S212 may be exchanged. Determination of whether the specific cell quantity is within, exceeds, or falls below the acceptable seeding quantity may be performed only for the first culture vessel. In this case, steps S29 to S213 illustrated in FIG. 11 are skipped, and in a case where the specific cell quantity does not exceed the first acceptable seeding quantity (NO in step S26), the processing circuitry 11 may proceed to step S214.

The second embodiment is also applicable even in a case where the pluripotent stem cell culture device 80 has a culture vessel smaller than the second culture vessel in size. In this case, procedures from the determination in which the specific cell quantity does not exceed the second acceptable seeding quantity (NO in step S211) in FIG. 11, which are steps corresponding to steps S29 to S213 may be added to procedures for a third culture vessel. This also enables cells of the specific type to be seeded in an appropriate seeding quantity even in a case having three or more culture vessels with different sizes.

In a case where the specific cell quantity is sufficient for seeding in a plurality of the first culture vessels in step S27, the processing circuitry 11 calculates the seeding quantity in such a manner that seeding is able to be performed to the plurality of the first culture vessels. For example, in a case where the specific cell quantity including the error bar 171 is approximately twice the minimum acceptable seeding quantity or more, the specific cell quantity is calculated in such a manner that seeding is performed to the plurality of the first culture vessels. In step S28, the seeding device 50 seeds cells of the specific type in the seeding quantity in a plurality of first culture vessels. In a case where the specific cell quantity exceeds the maximum acceptable seeding quantity, seeding cells in the plurality of the first culture vessels enables the efficiency of producing colonies of pluripotent stem cells to be improved, which eventually can reduce the number of cells to be disposed of.

According to the second embodiment, the suitable seeding quantity is able to be calculated in accordance with the sizes and/or the number of culture vessels.

The processing circuitry 11 may display the specific cell quantity and/or the seeding quantity on the display 13 like the first embodiment in a step after step S23 in FIG. 11.

### (Modifications)

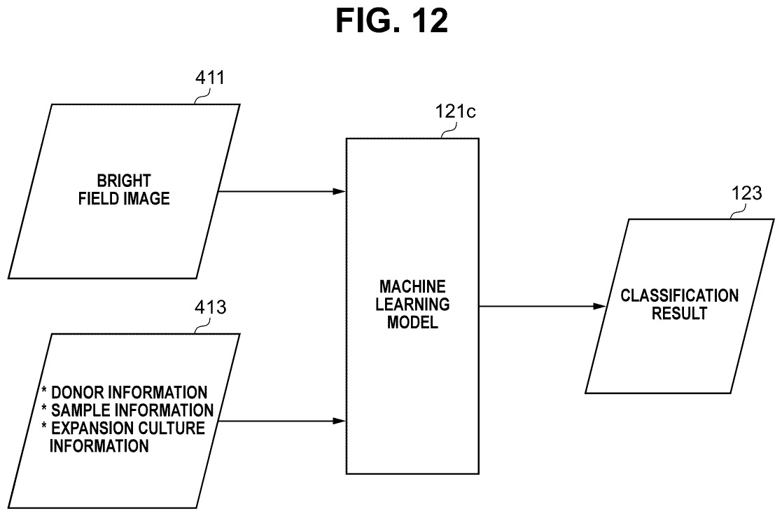

The machine learning model may receive input of information other than the bright field image and the performance indexes. FIG. 12 is a diagram illustrating another method for training a machine learning model and input and output to and from the model. As illustrated in FIG. 12, a learned machine learning model 121c inputs a bright field image 411 and information 413 including donor information, sample information, and/or expansion culture information, and outputs a specific cell quantity. The donor information includes the gender, height, weight, and medical history of a donor, for example. The sample information includes a specific cell quantity and the ratio of blood corpuscle cells before an expansion culture, and a sample bright field image before the expansion culture. The expansion culture information includes a culture time duration and a culture medium used. An unlearned machine learning model is subjected to parameter training by input of a bright field image that captures cells of the specific type, a label indicating whether cells captured in the bright field image are cells of a particular type, the donor information, the sample information, and the expansion culture information as training data so that the machine learning model outputs a specific cell quantity.

According to the modification, the processing circuitry 11 estimates the specific cell quantity by using the machine learning model 121c based on the donor information, the sample information, and/or the expansion culture information, whereby the specific cell quantity reflecting information before the expansion culture is estimated.

The modification may be applied to the first embodiment and/or the second embodiment.

According to at least one of the above-described embodiments, a seeding quantity suitable for obtaining a desired number of pluripotent stem cells is calculated.

The term “processor” used in the description of the foregoing embodiments refers to a circuit, such as a central processing unit (CPU), a graphics processing unit (GPU), an application specific integrated circuit (ASIC), and a programmable logic device (e.g., a simple programmable logic device [SPLD], a complex programmable logic device [CPLD], or a field programmable gate array [FPGA]). The processor implements functions by reading programs stored in a storage circuitry and executing the programs. Instead of storing the programs in the storage circuitry, the programs may be directly built in the processor circuit. In such a case, the processor implements the functions by reading the built-in programs in its own circuitry and executing the programs. If the processor is an ASIC, the programs are not stored in the storage circuitry. Instead, the functions are directly incorporated as logic circuitry in the circuitry of the processor. The processors according to the embodiments are not limited to a single-circuit configuration. A plurality of independent circuits may be combined into a processor that implements the functions. Further, a plurality of components in FIGS. 1 and 3 may be integrated into one processor which implements their functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising processing circuitry configured to:
acquire a bright field image that captures a cell group including cells of a plurality of types;
estimate a specific cell quantity regarding a quantity of cells of a specific type among the plurality of types, based on the bright field image; and
calculate a seeding quantity of cells or suspension including the cells of the specific type to be used in a following process, based on the specific cell quantity.

2. The information processing device according to claim 1,
wherein the specific cell quantity refers to a ratio of a number of cells of the specific type to a number of cells of the plurality of types, or a number of cells of the specific type,
wherein the seeding quantity refers to a volume of a seeding suspension containing cells of the specific type or a number of cells of the plurality of types contained in the cell group,
wherein the cell group includes human peripheral blood-derived mononuclear cells, and
wherein the cells of the specific type are CD34 positive cells.

3. The information processing device according to claim 1, wherein, by using a machine learning model having been trained by an input of a bright field image of training data to output a classification result of the cells of the specific type captured in the bright field image, the specific cell quantity is estimated from the bright field image.

4. The information processing device according to claim 3, wherein the seeding quantity is calculated further based on performance indexes of the machine learning model.

5. The information processing device according to claim 4, wherein the performance indexes include a positive predictive value, a negative predictive value, a true positive rate, a false negative rate, an accuracy, and/or a deviation of the machine learning model based on a classification result output in response to input of, as verification data, a bright field image different from the training data, and the verification data.

6. The information processing device according to claim 2, wherein the seeding quantity is calculated based on a target number of colonies of pluripotent stem cells to be cultured and a first acceptable seeding quantity based on a size of a first culture vessel to be subjected to seeding of the cells of the specific type.

7. The information processing device according to claim 6,
wherein the processing circuitry further configured to determine whether the specific cell quantity is within the first acceptable seeding quantity, and
wherein, in a case where the specific cell quantity is determined to be within the first acceptable seeding quantity, a total of the cell group is calculated as the seeding quantity.

8. The information processing device according to claim 7, wherein, in a case where the specific cell quantity is determined to exceed the first acceptable seeding quantity, the seeding quantity less than the total of the cell group is calculated in such a manner that the specific cell quantity falls within the first acceptable seeding quantity.

9. The information processing device according to claim 7,
wherein, in a case where the specific cell quantity falls below the first acceptable seeding quantity and is within a second acceptable seeding quantity based on a size of a second culture vessel smaller than the first culture vessel, the total of the cell group is calculated as the seeding quantity, and
wherein, in a case where the specific cell quantity falls below the first acceptable seeding quantity and exceeds the second acceptable seeding quantity, the seeding quantity less than the total of the cell group is calculated in such manner that the specific cell quantity is within the second acceptable seeding quantity.

10. The information processing device according to claim 1,
wherein the processing circuitry further configured to determine whether to dispose of the cell group, and
wherein the processing circuitry further configured to display information about the disposal of the cells of the specific type.

11. The information processing device according to claim 2, wherein the seeding quantity is calculated further based on donor information about a donor having provided the cell group as a sample, sample information about a cell quantity contained in the sample, and/or expansion culture information on the cell group.

12. A cell processing apparatus comprising:
processing circuitry configured to
acquire a bright field image that captures a cell group including cells of a plurality of types as a subject;
estimate a specific cell quantity regarding a quantity of cells of a specific type among the plurality of types by analyzing the bright field image; and
calculate a seeding quantity of cells or suspension including the cells of the specific type to be used in a following process, based on the specific cell quantity;
a seeding unit configured to seed the cells of the specific type in a seeding quantity corresponding to the seeding quantity from the cell group; and
a cell processing unit configured to process the cells of the specific type.

13. The cell processing apparatus according to claim 12,
wherein the cell processing unit cultures pluripotent stem cells from seeded cells of the specific type, and
wherein the bright field image captures the cell group having been subjected to expansion culture as a subject.

14. The cell processing apparatus according to claim 13, further comprising
a culture unit configured to culture seeded cells of the specific type in a first culture vessel,
wherein, in a case where the specific cell quantity is within a first acceptable seeding quantity based on a size of the first culture vessel or exceeds the first acceptable seeding quantity, the seeding unit seeds the cells of the specific type corresponding to the seeding quantity in the first culture vessel.

15. The cell processing apparatus according to claim 13, further comprising
a culture unit provided with a plurality of culture vessels including the first culture vessel for culturing seeded cells of the specific type and a second culture vessel smaller than the first culture vessel,
wherein, in a case where the seeding quantity falls below a range of the first acceptable seeding quantity based on a size of the first culture vessel and is within a range of a second acceptable seeding quantity based on a size of the second culture vessel, the seeding unit seeds cells of the specific type corresponding to the seeding quantity in the second culture vessel.

16. The cell processing apparatus according to claim 12,
wherein the processing circuitry further configured to determine whether to dispose of the cell group,
wherein the cell processing apparatus further includes a cell disposal unit configured to dispose of the cell group determined to be disposed of, and
wherein the processing circuitry further configured to display information about the disposal of the cell group.

17. The cell processing apparatus according to claim 13, further comprising
a culture unit provided with a plurality of the first culture vessels for culturing seeded cells of the specific type,
wherein, in a case where the seeding quantity exceeds a first acceptable seeding quantity based on a size of the first culture vessels, the seeding unit seeds cells of the specific type corresponding to the seeding quantity in each of the plurality of the first culture vessels.

18. The cell processing apparatus according to claim 12, wherein the processing circuitry further configured to display the specific cell quantity and/or the seeding quantity.

19. A method for determining a seeding cell quantity, wherein a computer performs:
acquiring a bright field image that captures a cell group including cells of a plurality of types;
estimating a specific cell quantity regarding a quantity of cells of a specific type among the plurality of types, based on the bright field image; and
calculating a seeding quantity of cells or suspension including the cells of the specific type to be used in a following process, based on the specific cell quantity.

20. A cell processing method comprising:
acquiring a bright field image that captures a cell group including cells of a plurality of types;
estimating a specific cell quantity regarding a quantity of cells of a specific type among the plurality of types by analyzing the bright field image;
calculating a seeding quantity of cells or suspension including the cells of the specific type to be used in a following process, based on the specific cell quantity;
seeding the cells or the suspension including the cells of the specific type in a seeding quantity corresponding to the seeding quantity from the cell group; and
processing the cells of the specific type.
